(19) United States
(12) Patent Application Publication
(10) Pub. No.: US 2002/0007292 A1
(43) Pub. Date: Jan. 17, 2002

(54) Method and apparatus for reserving a place in line

(76) Inventors: Mark S. Paxton, Lexington, KY (US); Michael F. Hughes, Bellingham, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/821,333

(22) Filed: Mar. 28, 2001

Related U.S. Application Data
(60) Provisional application No. 60/192,799, filed on Mar. 28, 2000.
(60) Provisional application No. 60/199,217, filed on Apr. 24, 2000.
(60) Provisional application No. 60/203,504, filed on May 11, 2000.

(51) Int. Cl. G06F 17/60

(52) U.S. Cl. 705/6

(57) ABSTRACT

A system to substantially reduce the lines for an attraction where the system comprises a central processor and a transmitter that emits signals to be received by a plurality of receivers. The receivers passively receive the signals from the transmitter and upload information to the central processor using common magnetic field interrogation propagation.

### RELATED APPLICATIONS

This application claims priority of U.S. Provisional application Ser. Nos. 60/192,799 filed Mar. 28, 2000; 60/199,217 filed Apr. 24, 2000; 60/203,504 filed May 11, 2000.

### BACKGROUND OF THE INVENTION

1. Field of the Invention

The invention relates to a system to substantially remove lines where a plurality portable receivers are employed to receive signals from a transmitter to review the status of the queue for an attraction. The receivers comprise inexpensive paging receiving technology and transfer data to a central processor passively using an H-field interrogator.

2. Background of the Invention

A search of the prior art has resulted in a number of patents directed to solving the general problem of removing lines in an amusement park. The most relevant patents are U.S. Pat. No. 5,978,770 Waytena et al., U.S. Pat. No. 5,987,421 Chuang, and Great Britain 2,307,324 and PCT application 97/18534 Nims. In general, these disclosures are directed to bidirectional pager units that transmit a signal from each units to a receiving antenna. There are numerous problems associated with a bidirectional paging system. The ramifications of having numerous transmitting portable devices (e.g. greater than 5000) results in various problems such as radiofrequency interference, failure to properly transmit and receive the signal sent by the handheld devices, and most notably, the increased cost of having handheld devices with active RF transmitting circuitry. The present invention employs standard circuitry for receiving paging signals from a transmitting antenna, whereas data from the handheld units are uploaded using an interrogator. An interrogator is common in stores and libraries to prevent theft of articles. In general, an interrogator emits a magnetic field where when a magnetically permeable and conductive material has a physical force and associated movement through the magnetic field and perpendicular thereto, a current is developed in the conductive material that is orthogonal to the magnetic field and the direction of the force. This current is employed to generate a signal that is received by a receiving unit in the interrogator. Therefore, it is not been found in the prior art such an implementation system having the various benefits disclosed herein. The Chuang, Sims and Waytena have functionality that is predicated upon having bidirectional portable communication devices. A description of the background art is as follows.

U.S. Pat. No. 5,978,770 Waytena et al., discloses a system comprising a wireless network or portable communication devices (PCB's) are employed to provide the patrons the freedom to roam an amusement park while having a place a virtual line for attraction. The system is predicated upon bidirectional PCB units as shown in FIG. 1.

U.S. Pat. No. 5,987,421 Chuang, discloses another bidirectional pager units embodiment. The disclosure is directed towards a bidirectional paging units system having more elaborate capabilities such as locating the handheld units within an amusement park.

Great Britain 2,307,324 and PCT application 97/18534 Nims, has a very similar disclosure to Chuang where a bidirectional paging units are employed. The disclosure calls for RF transmitters in the paging units similar to that as the RF transmitters in the keychain of an automobile keychain security system/locking-unlocking unit.

U.S. Pat. No. 5,974,393 McAuliffe et al. discloses a paging system for point-of-sale systems. The prospective customer views a screen to determine whether the merchant is ready to service them.

### SUMMARY OF THE INVENTION

A system to substantially remove lines for attraction for a number of patrons desired to attend the attraction. The system comprises a transmitter system having a transmitter device adapted to transmit radiofrequency signals, a central processor having a queue and a processing system. The processing system is adapted to transmit signals to the transmitting system to send information therefrom. A plurality of receivers where each has a unique identification tag are employed where the receivers are adapted to receive the information from the transmitter system. A queue setting operation comprising a first interrogator adapted to receive signals from the receiver where the first reader uploads unique identification tag of each receiver as the receiver passes therethrough. The first reader is in communication with the central processor to transmit information thereto. A queue decrementing operation has a second interrogator that is adapted to receive signals from the receivers where the second interrogator uploads unique identification tag of the receivers as the receivers pass therethrough. The second interrogator is also in communication with the central processor. An entrance regulation system that is adapted to permit or deny entrance to the attraction for the patrons where the entrance regulation system is controlled by the queue decrementing operation where when a place-holding is removed from the queue, the entrance regulation system is adapted to allow access to the attraction for the patron possessing the receiver having the unique identification tag of the place-holding that was removed from the queue. When a patron indicates the first interrogator of the queue setting operation a request to have a place-holding the queue, the central processor receives a request and creates a new place-holding on the queue where each place-holding comprises the identification tag. As higher priority place-holdings are removed from the queue, the lower priority place-holding's advance in the queue as receivers pass through the second interrogator, the unique identification tag is sent to the queue decrementing operation where the unique identification tag is transmitted to central processor to query for a place-holding having the same unique identification tag and its place-holding is within a specified high priority range the entrance regulation system allows the user to enter the attraction.

### BRIEF DESCRIPTION OF THE DRAWINGS

FIG. 1 is a flow diagram of an embodiment of the present invention;

FIG. 2 is a flow diagram of an embodiment of the present invention having the patron input a confirmation;

FIG. 3 is another flow diagram of the present invention;

FIG. 4 is a flow diagram of an embodiment of the present invention where the user must determine which ride lane to enter;

FIG. 5 is an isometric view of a receiver that is attached to a wristband;

FIG. 6 is a schematic isometric view of an implementation of the present invention employment a display unit and two sets of interrogators;

FIG. 7 is a flow diagram employing the embodiment as shown in FIG. 6;

FIG. 8 is another flow diagram of the present invention;

FIG. 9 is a schematic view of an implementation of the preferred embodiment.

### GENERAL DESCRIPTION OF PREFERRED EMBODIMENTS OF THE PRESENT INVENTION

In general the invention is a virtual line implementation that is particularly advantageous in amusement parks where there are long lines for amusement rides. More particularly, the invention is a system where there is a central processing center and a plurality of receivers on the persons who are in the virtual line. The processing center comprises a transmitter and a central processor. The receivers are adapted to receive signals from the processing center to give the user feedback on when she should journey back to the ride location.

There will first be a discussion of the overall operations of the present invention followed by a detailed description of several embodiments to most adequately inform the best mode of making and to help secure the proper breadth of the claims.

In general, a visitor entering in amusement park would pay their entry fee and also make a deposit for a receiver. The amusement park employee would then enter in the visitor's personal information into the central processor in order to identify the particular receiver with the visitor. Then the amusement park employee would hand a receiver to the visitor and the visitor would keep the receiver on their person.

Now the visitor would like to go on an amusement ride. Many popular rides in amusement and theme parks have crowded lines were the wait to get on the ride can exceed an hour and occasionally stretch to more than two hours. At this point the visitor would select a ride that she would like to go on and this information is conveyed to the processing center.

At the processing center the central processor intakes the visitor's ride request along with the ride requests from all the other visitors in the park (or not in the park disclose in a further embodiment). The central processor will then send the information to the visitor giving them a virtual placeholder. The virtual placeholder can be determined by many methods described herein. The most basic method is first in time, first in line. For example, if 1000 visitors have already requested to go on the ride our visitor is interested in, then our visitor would be the 1001 person to go on the ride at the time she made the request. So for example, if the ride takes 10 occupants every two minutes, then our visitor would have approximately a 200-minute (three hours and 20 minutes) time-lapse wait to get on the ride. This length of time standing at a traditional line of people is physically and psychologically taxing to the patron and is not very enjoyable. However, because the visitor has a virtual placeholder in the queue at the time of her request she has the 1001 spot which of course counts down (10 per two minutes in our example) as other visitors that have high priority placeholders ahead of our visitor's placeholder go through the ride. During this interim time our visitor can look at other portions of the park or even go on less crowded rides that have a lower wait time.

Another featured of the present invention is a trading system where if a visitor wants to give up her placeholder she can trade it with another via the central processor. For example, let us expand upon our previous example and say our visitor has entered the waterpark portion of the amusement park and is going to be there longer than expected and will not arrive at her requested ride at her expected arrival time. In this scenario, the visitor can request an extended timeslot which is not at the very end of the timeslot listing, but rather is at an intermediate lower priority time between the position of her a place-holding and the very end of the timeslot listing. This allows the visitor flexibility in selecting her ride time without foregoing any place-holding rights she has acquired thus far.

Of course, if our visitor moves to a lower ranking place-holding position then the place-holdings behind her will be at a higher place-holding ranking. This may not be desirable for these visitors with in between place-holdings because they need the time to do other activities. Due to the consistency and predictability of the amount of people per unit of time that can go to the ride, our users repositioning of her placeholder leaves and open place-holding.

The system provides a method of occupying the spot by allowing the opportunity for visitors to make bids on a higher priority place-holdings. This entails a visitor to request a higher place-holding in a line. This request is received in the central processor which determines if there are any open positions for a placeholder ahead of the visitor's present placeholder. If there is an open place-holding, this information is conveyed back to the visitor and he can accept or reject the newly proposed place-holding.

Certain visitors without a planned agenda may want to “take a chance” to get on rides by requesting a place-holding on the supplemental queue. The supplemental queue is a list of place-holdings to fill in open spots that develop in the queue. A visitor would choose the rides that he would like to go on and make a request to be on the supplemental queue. As visitors with place-holdings in the regular queue dropout for various reasons, open spots in the queue develop. These open spots are filled by place-holdings in the supplemental queue. So for example, say a visitor places his name on three ride's supplemental queue (rides A, B, and C). Let us further say ride B has an opening in the queue that has an estimated time of arrival of 10 minutes for example. The visitor can now affirm that he would like to accept this place-holding and he can travel to ride B and check-in. When the visitor confirms his place-holding in the queue he is taken off the supplemental register for ride B and the place-holding he filled is no longer open. When he arrives to the ride and checks in then he is confirmed to get on the ride just as other visitors in the queue.

One potential problem with giving visitors a countdown timer to go to ride is that anxiety develops as time is counting down and they do not know the distance to the ride and the time required for them to travel to the ride from their present location. This problem is alleviated by using a positioning system (discussed infra) to determine the visitor's average rate of speed and their location from the ride to give the visitor feedback on their timing. The positioning system is preprogrammed to know the routes from any point in the park to any ride or other destinations of interest.

In this embodiment, the central processor is programmed to be aware of the geographical location of every individual in the park, the central processor could advise a route that has a lower density of people. In other words, if there are too many people on a path to where the capacity of the path is exceeded, then the central processor could suggest an alternative route for the visitor. This alternate route could be longer; however, given the higher average rate of speed the visitor could travel, it would be the quickest route. The central processor could further determine the visitors average walking speed, and if this walking speed does not exceed the mean speed in a particular route, then that route may be more suitable for the visitor. If however, a visitor (visitor B) is a fast walker then the central processor may recommend a less crowded route, albeit longer, to optimize the lowest travel time for visitor B.

If the central processor detects that the best travel time exceeds the available time the patron has the get to the ride, the central processor will send a signal to the receiver indicating this dilemma. If the patron agrees that they cannot make the ride and time they can accept a higher open place-holding in the queue.

The open place-holdings in the queue will be given to patron's who could not make it to ride as well as patrons in the supplemental queue. A priority scheme would be enforced to divvy up to people who are late and those in the supplemental queue to get the open place-holdings when they become available.

A further feature of the present invention is for two or more visitors to collaborate and go on a ride together.

The queue would be divided into sections and each section would represent the number of people to occupy a full ride load. For example, a contiguous section of roller coaster carts that are loaded and unloaded with people at the same time is referred to as a ride load.

Another feature of the present invention is to allow visitors to make request on specific seats (e.g. the first two seats of a roller coaster ride).

The central processor can further generate a plan for a family or individual. For example, a family would enter in specific data regarding the family members (e.g. number of people, height of each person, age of each person, etc.). A family member would logon to a web site, which is an ASP (application service provider) and connected to the central processor. The family member would enter in the data of his family and the specific rides and festivities that they want to see and go on. This request is submitted to the central processor and the central processor formulates an agenda based upon the place-holdings from other patrons that are already reserved in the projected queues for that day and the results from a regression analysis discussed further herein. Based on this information, the central processor can plan an agenda for the family. The agenda can be specific or general. A more specific agenda would include the exact times the family would eat and what meals they would have. When the family arrives at the restaurant within the theme park the meals would be ready for them at that specific time. A more general agenda would reserve the family timeslots to go on specific rides at certain times of the day and leave timeslots open thereinbetween for the family to walk around the park.

The agenda could also be flexible enough to account for some agendas for individuals or groups of individuals within the family (or any other group). For example, let us say a family of six is comprised of three groups: the parents, two brothers, and two sisters. In the morning the three groups would like to go on different rides and see the different attractions, in the afternoon the family like to get back together and go to lunch and thereafter all go on a ride or to an event (e.g. a show). The user interface would give the family member setting the agenda an opportunity to subdivide the family into subgroups. Then each subgroup would use the rides they would like to go on at approximate times. Alternately, each subgroup could choose the rides that they would like to go on and let the central processor decide the best times. The central processor would coordinate each subgroups' activities so each group can meet at a fixed time to eat lunch, for example. The system has the flexibility of thereafter combining the subgroups into the master group (i.e. the family) and coordinating the family for rides and events.

When the day is over, the family can receive a statement of their modified itinerary so they know what activities they did during that day. The user interface would then ask each member of the family what rides and activities they enjoyed providing them several criteria (e.g. overall quality, exciting, a rating from 1 to 5). This information is used for regression analysis where the inputs from the individual are compared to the inputs from previous individuals to determine what future rides this individual would enjoy. In other words the regression analysis would take into account the correlation between the rides the individual has rated to the ratings of previous individuals. Then the regression analysis would project what rides the individual would likely enjoy as well. For example, let us assume the individual enjoyed the exhilarating rides and rated them very highly. The regression analysis would compare the high ratings with the high ratings other individuals have given these exhilarating rides. Then the regression analysis would look at other rides the individual has not yet gone on. Out of those rides the regression analysis would choose the rides previous individuals with a similar profile rated highly as well.

The regression analysis could also take into consideration other factors such as the weather, time of year, if the day is a weekend, time of day, etc. If the weather is poor, it may be a causal factor to deter local patrons from entering the park. Hence, this would factor in to a less crowded park.

Another option given to the family is a basic package where the family enters in minimal inputs and the central processor reproduces an agenda which acceptable to most patrons.

Another feature of the present invention is by using the positioning system when a patron leaves the park with a receiver. This will be detected by the central processor and a small alarm will go off in the receiver to warn the patron. If the patron takes the receiver then it will cease to be functional.

Some advantages of the present invention are:

Optimize park usage and draw more people;

Keep track of ride usage;

Parks can predict if there will be low attendance and make appropriate decisions regarding staffing and pricing;

Interaction with patrons in the form of a web site;

Better use of patron's time and greater utility to the consumer;

The central processor would give feed back based upon request.

Choreograph people in advance, no downtime where featured attractions are not attended;

In a portable device transmitting version, controller is directional dependant and will show best direction to destination;

Allow flexibility for patrons without an agenda who want to “roam” the park.

### DETAILED DESCRIPTION

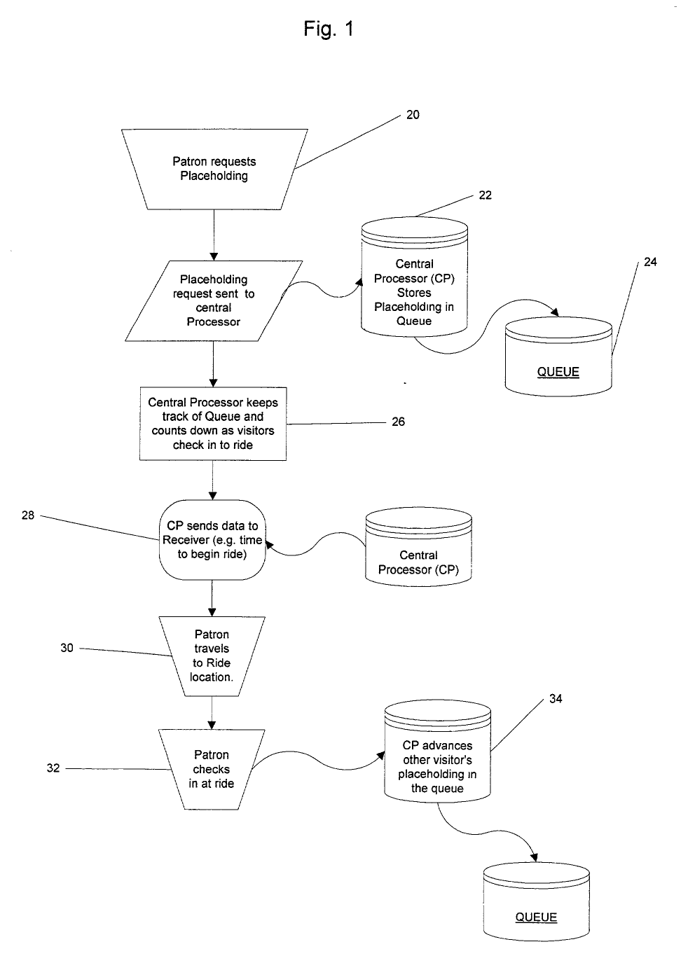

The basic operations of the first embodiment of the present invention are as follows. As seen in FIG. 1, the user requests a place-holding on the queue and this is indicated at 20. The request can be made by a variety of potential input methods. Varieties of different methods are discussed below for exemplary purposes with the understanding that the basic principle is that the central processor receives a digital input for processing. The request is then sent to the central processor indicated at 22. The central processor then places the request on the queue 24. The queue is a dynamic data structure that keeps track of the number of requests and associated data therewith. The request itself contains the unique ID that is associated with the patron who made the request. Additional data fields can be associated therewith such as the time the request was made.

After the request has been made the patron can travel about the park freely. In the meantime the central processor is decrementing the queue with respect to our patron's place-holding as other patrons show up for the particular ride and check-in. Further, the central processor keeps track of the patrons that have not checked in and leaves open spots (slots) in the queue (see 26 in FIG. 1). The issue of open slots in the queue is discussed further herein.

The patron's placeholder increases in the queue as other patrons ahead of her advance. At a predetermined time estimate, the central processor will send a signal to the patron's receiver to inform the patron that she has a certain amount of time to travel back to the ride location and check-in. At this point the visitor will travel to the ride location (30) and upon arrival she will check-in indicated as step 32. When the patron checks in the Queueless™ process is complete for this patron (for this particular ride) and the central processor will remove the patron's place-holding from the active queue. The removal of her place-holding from the queue will advance the other place-holdings to a higher priority in the queue that were behind the patron in our example (see step 34).

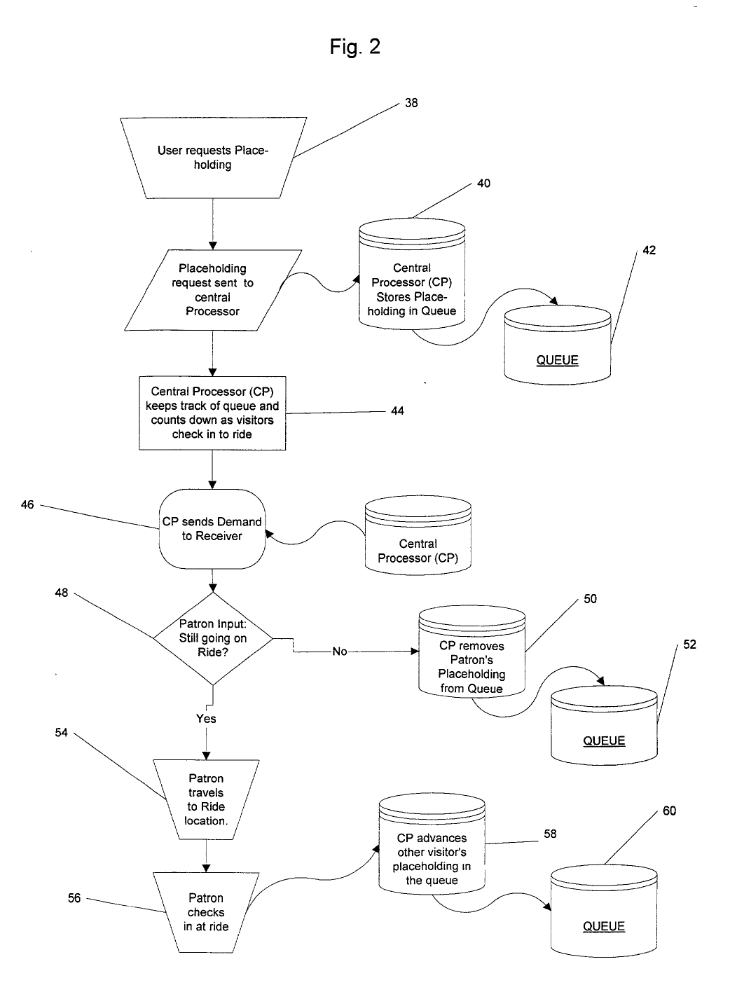

A second embodiment of the present invention is shown in FIG. 2. In this embodiment the patron is given a choice as to whether she wants to go on the ride at her predetermined place-holding in the queue, at a lower priority position in the queue (a little bit later) or not all.

The first steps are similar to that of the first embodiment in FIG. 1 where the user requests a place-holding (again the methods of requesting a place-holding is discussed further infra) indicated at 38. This request is sent to the central processor 40, which places a place-holding identifying the user onto the queue 42. The central processor keeps a running count of the queue and decrements place-holdings as other patrons check-in to the ride when requested or miss the ride altogether (see 44 of FIG. 2). At a predetermined time interval, the central processor will send a demand to the specific patron indicated at step 46. As seen in FIG. 2, the demand is of a Boolean nature where the patron must decide whether or not she is going to make it to the ride. If for example, the patron is enjoying her time at the waterpark and cannot possibly get ready in time for the ride she can simply deny the demand and the central processor 50 will then remove her place-holding from the queue 52. This demand step can be very useful for handling open spots that develop in the queue. It is advantageous to have the leadtime from when the demand is made to when the patron is expected to arrive at the ride (e.g. 15-30 minutes). This leadtime provides the central processor more time to address the problems of open slots developing in the queue discussed infra.

If the group tracking embodiment is employed then the parents can handle the request and account for all members in the group (presumably small children).

If the patron accepts the demand, then the process is similar to that of the first embodiment where at step 54 the visitor begins to travel to the ride location and when arriving checks in (step 56). Preceding the patron's second the central processor 58 will remove her place-holding from the queue at step 60.

The bilateral communication between the central processor and the patrons' receivers can be accomplished by a variety of transmitter/receiver implementations. A conventional radiofrequency (RF) transmitting schemes could be employed. A number of transmitting and receiving antennas could be placed at strategic locations around the park to transmit and receives RF frequencies. Presumably, the RF ranges used would not be in the FCC licensed spectrum, but rather a low wattage open frequency signal spectrum would be used. The antennas should be placed in a manner to allow triangulation deduction geographic positioning of the devices. Further, the local antennas could interface with a satellite. This would allow less hardwiring to be installed in an amusement park. The satellite would relaying the messages from the local antennas to a central satellite signal receiver that communicates directly with the central processor. However, the preferred form of transmitting data from a traction location to the central processor is using a spread spectrum radio system described further herein.

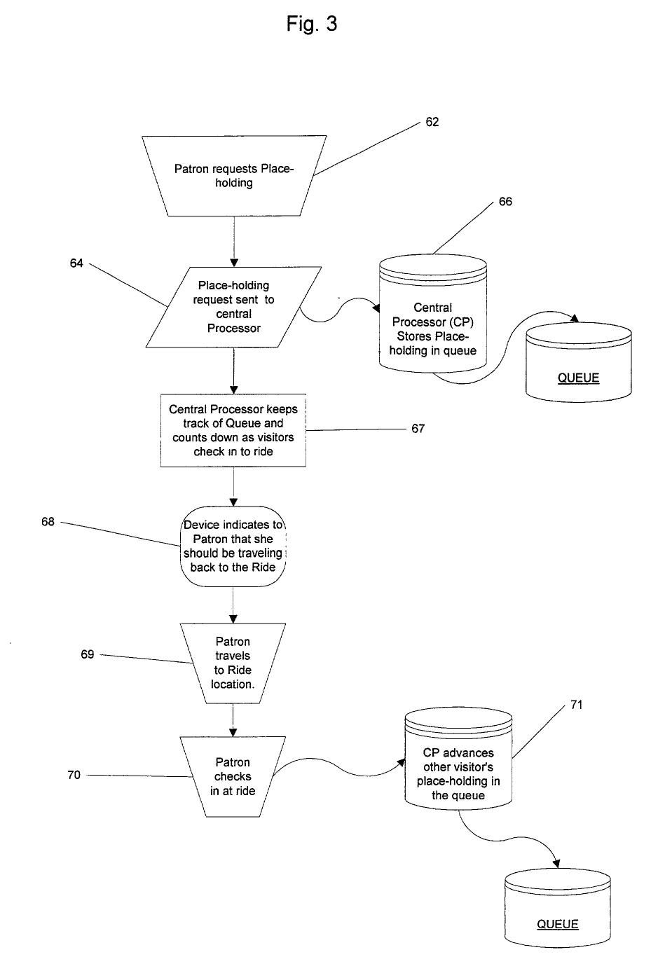

FIG. 3 shows a third embodiment where the receiver is replaced with only a timing device. In general, once the patron requests a place-holding on the queue this activates a countdown timer on the patron's timing device. After the central processor sets the timer, no further communication takes place between the central processor and the patron's device until the patron checks in to the ride at her designated time. This embodiment has a lower upfront cost for implementation since it does not require any long-range RF transmission between a transmitting center that is connected to the central processor and the devices carried by the patrons. As seen in FIG. 3, the patron makes a request at step 62. As with the previously mentioned embodiments this request can be executed by the patron walking through a sensing device such as an H-field interrogator that one commonly sees in a library, for example. Other methods of making a request could include running the countdown timer device through a magnetic scanner where the device passes its unique ID through the scanner and this unique ID is transmitted to the central processor. However, the request system must be a very expedient process (handle a large volume of requests for unit of time) so a line does not develop at the request stations. When the device is set two data structures are transmitted thereto: the countdown time value and the number ID. The place-holding request is sent to the central processor (64) and the central processor (66) increments the queue to indicate that another patron should be accounted for when assigning the next number ID and countdown timer. Of course, as patrons are placing requests, other patrons are checking in at the ride location and decreasing the total queue count (67) so the queue size is dynamically advancing and decrementing.

At a predetermined time the patron's device will indicate to her that she should begin traveling back to the ride location (68) at which point she would begin traveling back to the ride location (69). It should be noted that this warning indicator sent to the patron is executed locally by the device without respect to the central processor because no communication to the central processor is available. When the patron gets to the ride location she checks in (70). At check-in the central processor will acknowledge her arrival and decrement the queue.

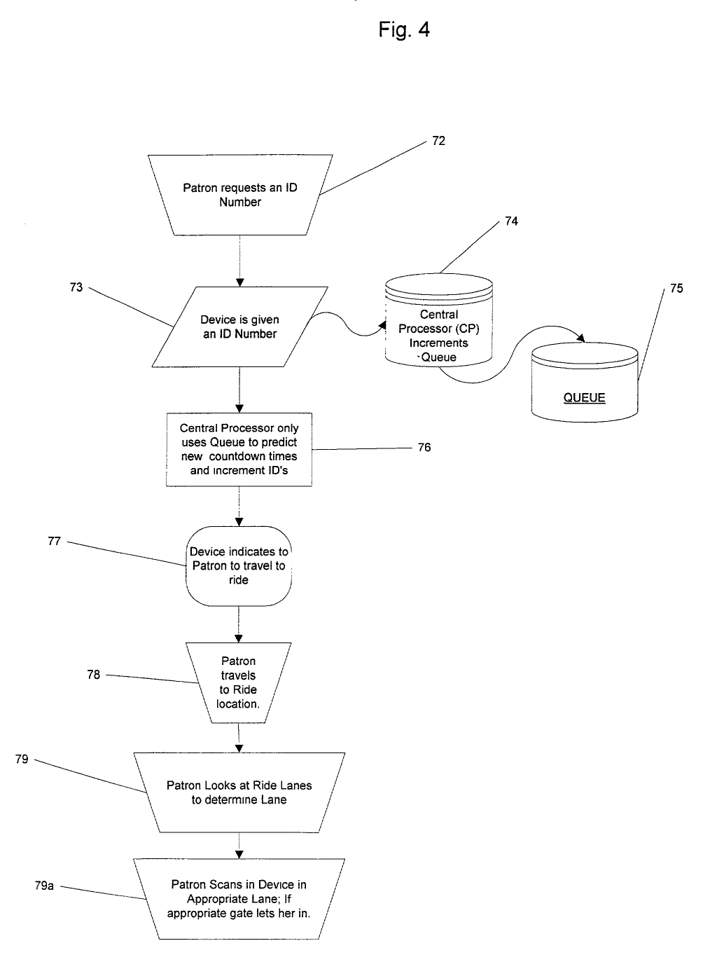

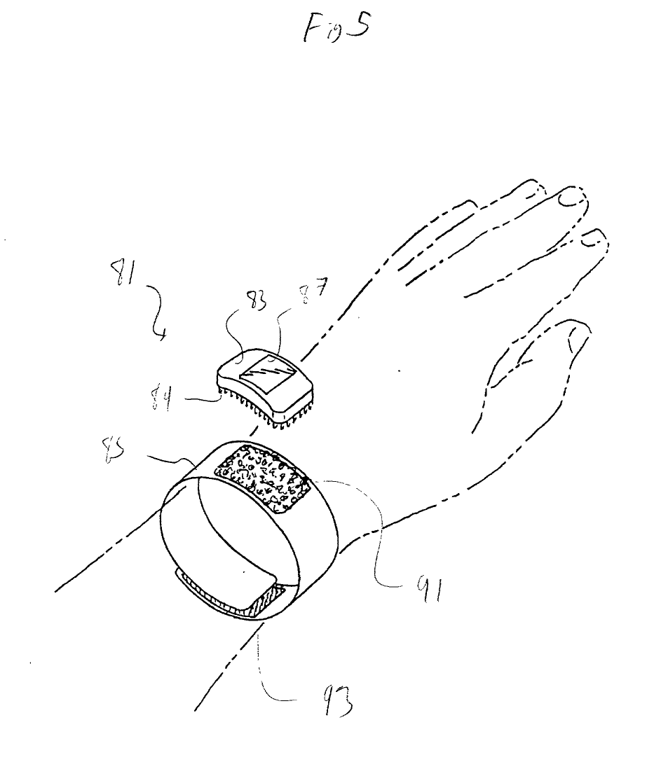

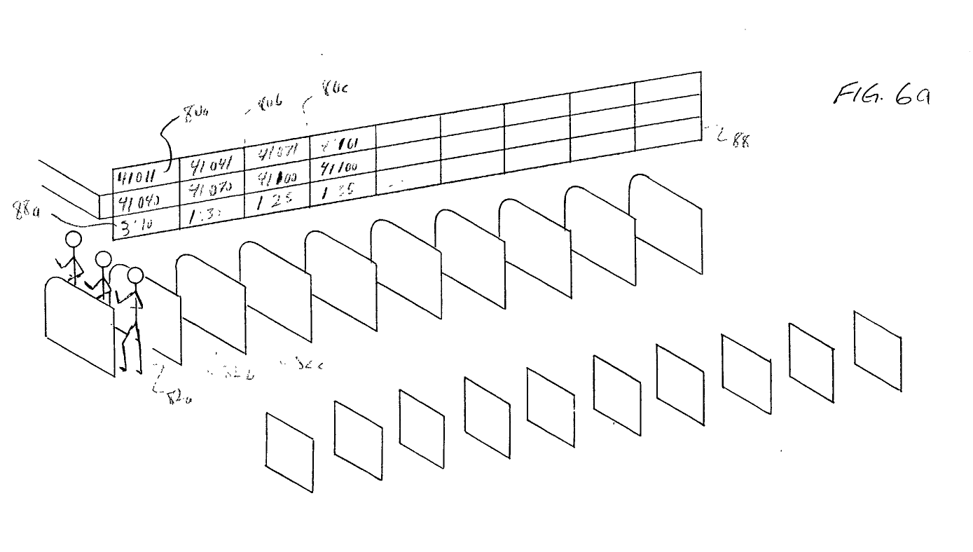

The fourth embodiment shown in FIG. 4 is similar to the third except no identification of the patrons is stored in the queue. This is the simplest design and could be implemented as a first phase in a testing environment for the present invention. As seen in FIG. 4, the patron first requests an ID number. This request can be done in a number of ways. As mentioned before, the patron could walk through a magnetic field interrogator with the device or she can scan it through a magnetic scanner, or a park attendant could simply handout the device and can make requests for place-holding on the queue. At any rate, two data structures of information are conveyed to the device (see step 64 in FIG. 4). One is the numerical time value that the device begins a countdown therefrom. The second piece of information is an ID number that is stored within the device. Both of these data structures are displayed on the device to the patron. When the request is made the central processor increments the queue. In this embodiment the queue is less sophisticated in that it only stores the total number of patrons that are to be going on the ride. Unlike the other embodiments this embodiment does not store the unique ID of the device. Rather, the queue is only used in this embodiment for predicting the countdown timing value that is sent to device is as people make place-holding requests. Further, the queue is used to increment the ID numbers in a chronological fashion as patrons make requests. The use of the ID numbers will be discussed further herein when the patrons return to the ride.

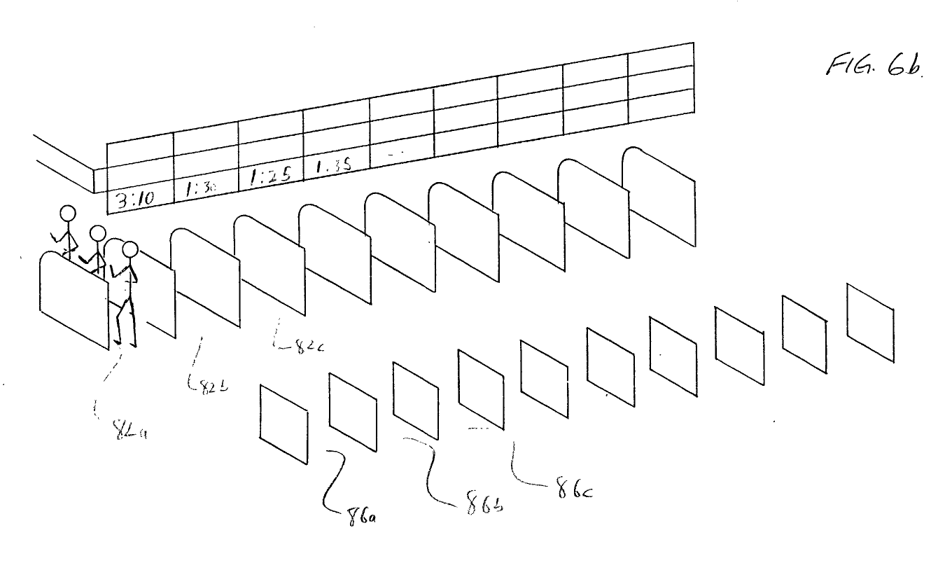

The receiving unit itself for all the embodiments is shown in FIG. 5, where there is shown the preferred form of implementing the receivers of the present invention. In general, the receiver unit 81 comprises a detachable receiver 83 and a flexible wristband 85. The receiver 83 has a display interface 87 that is preferably an LCD screen displaying text messages to the patron. The receiver contains the common circuitry for receiving paging messages as well as the passive interrogator tag to be read from an interrogator described further herein. The bottom portion of the receiver 83 is a coarse Velcro section 89 which is adapted to engage the softer Velcro section 91 of the wrist strap 85. The wrist strap 85 has a connection portion 93 that could further be a Velcro system or other inexpensive attachment mechanism. In a preferred form, the wrist strap 85 would have a merchant's logo imprinted thereon for advertising purposes.

To remove the costs of washing and maintaining the wrist straps 85, the preferred method of employing the present invention is to disperse a wrist strap 85 to the patron, and further give the patron a receiver 83. The patron would attach the receiver to the wrist strap and use the receiver in accordance as described herein. At a later time, when the patron is leaving the amusement park, she can return the receiver unit 83 to a returning kiosk and get credit for any deposits made on behalf of the receiving unit 83 and the patron to thereafter keep the wristband 85 as a souvenir. Further, a merchant such as a soft drink distributor could imprinted their logo on to the wrist strap 85 for advertising purposes creating an additional revenue stream. The coarse section of the Velcro 89 could be placed upon the wrist strap 85, which could be useful for scratching and itchy area of skin on the patron. Further, an attachment loop opening could be employed on the receiver 83 to allow a string to pass therethrough in the event the patron desires to carry the receiving unit 83 around their neck. The receiver 83 has a sufficiently low mass so any accelerations that the patron would experience would not remove the receiver 83 from the strap 85.

In an alternate form, the receiver 83 could have an audio output line for the visually impaired where a pair of headphones would plug therein to a receiving jack and audio output could be supplied to the patron who cannot visually see the display screen 87. The receiver 83 could further have a vibrating implementation as well as a noise generating functionality to indicate to the patron that she should look at the display screen 87. Further, a light emitting diode that attracts attention by the patron could be employed as well as a display screen 87.

The display screen 87 is adapted to displaying text messages that could be sent to the patron from in other individual in the patron's party. This is accomplished at a kiosk where another patron identifies the patron to send a message thereto and types and the text messages such as “meet me at the fountain, patron x” because the preferred form does not have any active transmitting implementation, messages sent to other individuals in the park are accomplished through a kiosk interface.

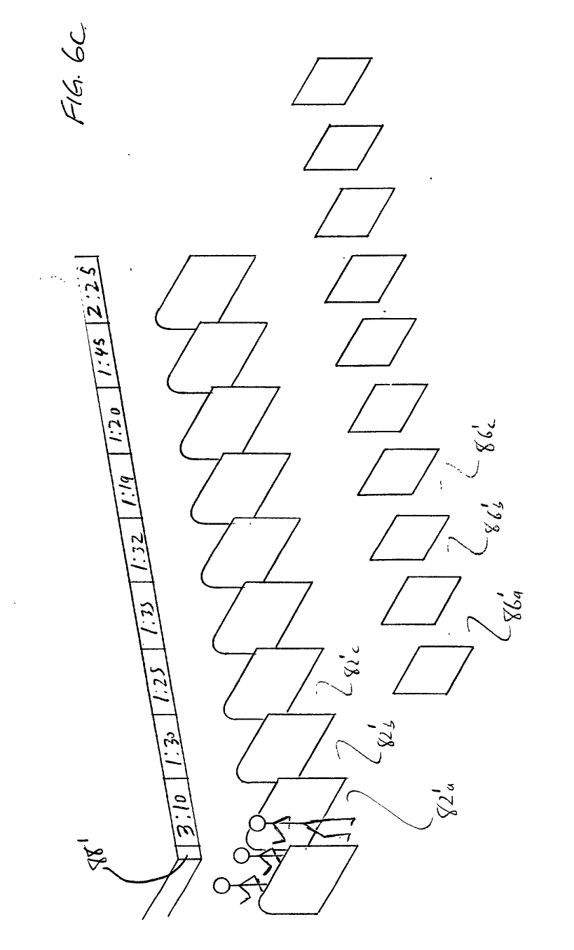

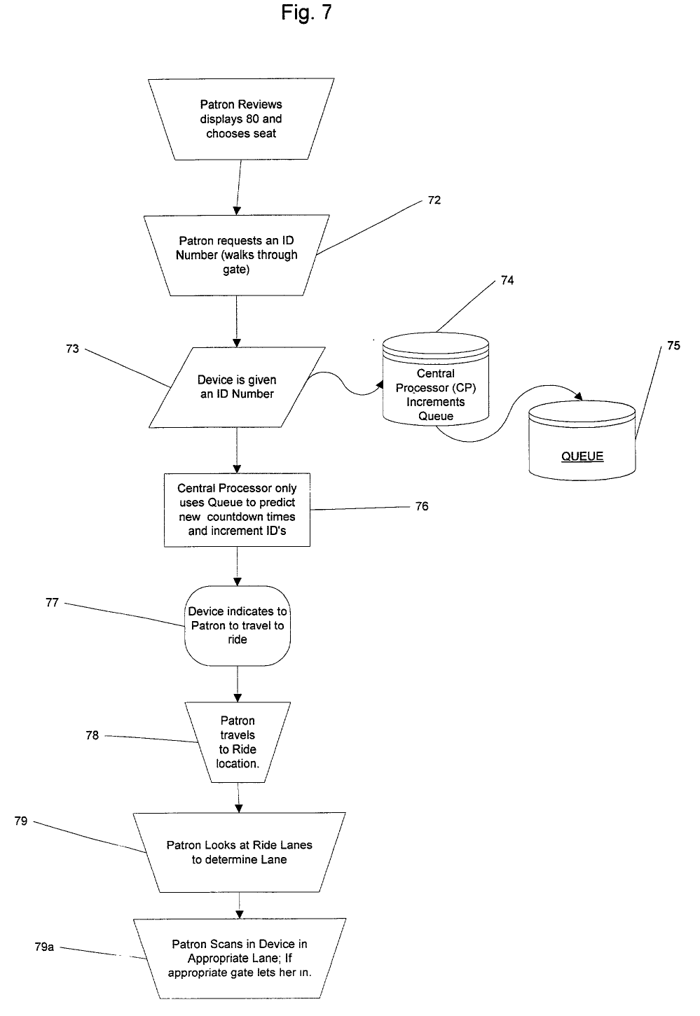

Now referring back to the fourth embodiment, after the patron makes a request there is no further communication with the central processor until check-in. At a predetermined time during the countdown (e.g. 15 minutes), the device will indicate to the patron that she should begin to travel back to the ride location (e.g. it will vibrate). When the patron gets to the ride location she will then look at the display of her device to find her number ID (see FIG. 5). The patron will then look at the display screens 80 above the entrance gates 82 (see FIG. 6). The display screens 80 indicate a range of number IDs that the particular entrance gates 82 are presently admitting. For example, in our situation the patron has an ID of 41,084 that was given to her when she made her request (72). As she travels up to the entrance gates she will look at the display screens 80 to determine which gate she may enter in. As seen in FIG. 6, the display screen 80c indicates 41,071 in the upper portion and 41,100 in the lower portion. This indicates a low value and high-value of a range. At this point our patron would determine that 41,084 is in between 41,071 and 41,100. She would then venture to the gate 82c and transmit her device through the device receiving mechanism 84c. The device receiving mechanism reads the patron's ID and queries this ID with that specific gate's ID range. If the ID is in between the range the patron will be allowed admittance. This would include access through the standard tri-bar rotating mechanism and perhaps a small green LED located near the receiving mechanism 84c. If the patron mistakenly went to the wrong gate then she would be denied admittance therein by the entrance regulator system. The display screens 80 could be constructed from illuminating display devices that are common in the industry such as LED grids. As the patrons cycle through the ride they would be taken in an orderly fashion from each gate. One possibility is to take all of the individuals within a gate as a batch to fill up all the seats of the ride. The other possibility would be to take two people at a time from each gate to fill in the seats of the ride as the seats become available (this is discussed in the fifth embodiment shown in FIG. 7).

It should be noted that the display screen 80 would change as the queue counts down and individuals check-in and their place-holdings are removed from the queue.

A variation of this embodiment would be to store the ID number in the queue that was given to the individual. Then when the individual checks-in, the queue can decrement its total value and record in a database the occurrence that this ID is now at the ride.

Another variation of this embodiment is shown in FIG. 6b. This embodiment accommodates the issue that certain patrons desire specific seats on a ride. For example, the front seats on a roller coaster are generally more popular and hence a number of patrons would rather wait a longer time for these desired seats. This situation can be addressed by modifying the request system in the fourth embodiment. As seen in a lower portion of FIG. 6, the slots 86 allow for patrons to pass therebetween and hence receive a number ID and a countdown timing value. The slots correspond to particular seats in a ride. As seen in FIG. 6 the slots correspond roughly to the gates where slots 86a correspond to 82a, 86b to gate 82b, etc. assuming that each gate leads to a specific ride location the patrons can choose which seats they want to go on. Of course as mentioned previously, some seats are more desirable than others and hence a greater demand exists for the seats. Therefore a second display 88 is employed that shows the approximate wait times (countdown times) for each ride. So for example, the display 88a shows a wait time of 3:10 (three hours in ten minutes). Whereas the wait time in the third seat from the back indicated at gate 82c is only 1:25 (one-hour and twenty-five minutes). Therefore the consumer (patron) has a choice of weight time and ride seat location. If she desires to wait a longer period of time for the front seats of the ride she can do so. If she wanted to take the statistically shortest wait she would choose gate 82c and hence travel through slot 86c to get her ID number and approximate countdown time. This variation of the fourth embodiment is advantageous for couples who desire to go on a ride together. In this case the couples would travels through the desired slots and be assigned proximate ID numbers. Hence, when their ID range is displayed on the display 80 they can enter at the proximate same time and situate themselves to go on a ride together. This removes the possibility of the couple having to go on separate seats in a ride and not sit together.

Of course the check-in does not need to be near the ride; however, is advantageous to do so because the patrons will have a higher probability of knowing how to get back to the ride. Further, having the check-in near the ride provides the patrons the opportunity to visually inspect the ride to determine if they want to go onto it. If the check-in is not near the ride the patrons may get confused as to what ride the request was made.

This embodiment employs receivers that only passively receive signals from the transmitter. The information is transmitted to the central processor through the magnetic H-field interrogators. It is possible to update the queue in the park through kiosks. In this modified form, the patron would scan her receiver through a mini magnetic interrogator or otherwise type in their identification tag to the kiosk and a user interface would allow any updates the patron requests.

For example, if the patron receive a signal from the transmitter that she has 20 minutes to attend the attraction and she would like to be placed at a lower priority place-holding on the queue, the patron would make a request at the kiosk for a lower priority place-holding to replace the present higher priority place-holding. The user interface system on the kiosk in one form would retrieve lower priority place-holdings that have recently become available and display the proximate wait times for these place-holdings to the patron. Then the patron can choose the proximate new wait time. Thereafter, the patrons previous high priority place-holding will become open or unoccupied and the lower priority place-holding she chose will now correspond to her tag number.

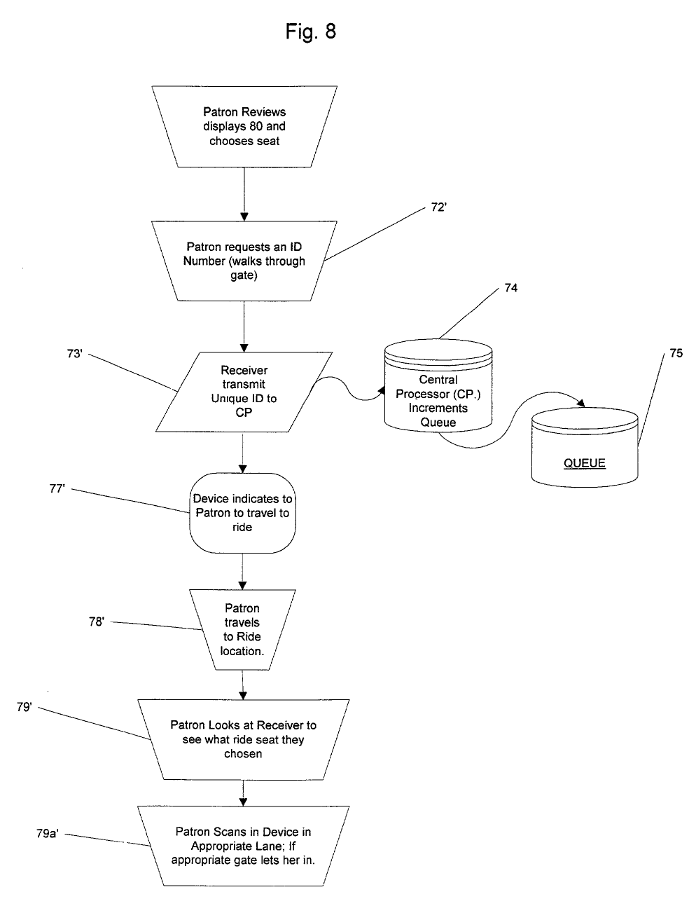

The most preferred form of implementation is shown in FIG. 6c with reference to the FIG. 8 flow diagram. In general, the display interface 88′ only displays the approximate weight times per ride seat on the attraction. After the patron walks through one of the interrogator stalls 86 corresponding to the ride seat associated therewith, the patron has a place-holding on the queue. It should be noted that there are actually a plurality of queue that are corresponding to each ride seat for the attraction. Therefore, the implementation as shown in FIG. 6c, there are nine queues corresponding to the nine respective ride seats. In this form, the device is not given an ID number, but rather periodic messages are sent to the receiver 83 indicating the approximate countdown time. When the patron returns back to the attraction location(78′), the display unit 87 of the receiver 83 will indicate which ride seat she should venture to, in case she forgot which ride seat she requested(79′). It should be noted that as the patron's place-holding advances in the queue, the place-holding is given a higher priority status. A higher priority status for a place-holding would call for more frequent paging transmissions to the receiver 83. Therefore, the receiver may be updated every few minutes as opposed to every 10 or 20 minutes. As the patron passes through the second H-field reader 82, she is removed from the queue and the interest regulations system (not shown in FIG. 6c) would allow her passage to the ride seat. A small line could exist after the interest regulations system (which could be a tollgate).

This form of the present invention is preferred over others because it is very simple and it caters to the lowest common denominator of patrons that would enter the park. Hence, this form provides the most functionality and consumer customization where the patron decides which ride seat use on the attraction. Further, this embodiment provides feedback as the approximate weight times of different ride seats and does not clump all patrons into one single line. Further, as mentioned above, having passive receiving devices that only upload information to an interrogator can reduce the costs of implementation four to ten times than that of bidirectional paging units. Therefore, the park does not have to risk significant capital expenditures for expensive hand-held units or resort to demanding very high deposits that might irritate the patrons.

With the foregoing in mind, a detailed description of the preferred implementation will now be discussed employing a system where the receivers only passively receive radio frequency signals and passively upload data to the central processor by moving through magnetic fields.

In general the preferred form of implementation comprises modern radio frequency identification, spread spectrum telemetry and narrowband FM paging technology. As stated above, the park patron establishes a place in line by simply walking through an archway, or even simpler two small uprights as seen in most department store security exits. On walking through the archway, a miniature ID tag attached to a pager with a unique identification number would be interrogated and read. Thereafter, a packet of information containing the patron's ID and the particular amusement's ID would be transmitted to a central processing station (CPS). The CPS would in turn receive the transmitted packet, note the time the packet was received, electronically place the patron in the queue for the respective ride and finally transmit a packet of information with the patron's pager ID, the ride ID and lastly the recommended time to return to the amusement for entry.

The system requires the use of three different forms of radio communications technology: radio frequency identification, spread spectrum, and narrow band FM radios. Each of these radios serves a different function in a communication chain necessary for system functionality.

Radio frequency identification or RFID is commonly used in anti-theft applications in department stores and other retail situations where shoplifting is a threat. Although there are several variations, it is fundamentally composed of two primary components: the interrogator and the tag. The interrogator generates an electromagnetic field with a predominant H-field. This field is directed in whatever space the associated tag is expected to pass through. The tag itself embodies a miniature microprocessor which contains a small amount of preprogrammed data that is read upon entering the field of the reader or interrogator unit. On entering the H-field of the interrogator, the tag uses a small amount of the interrogator's field energy by rectification. This allows the tag to power itself up, backscatter modulate the field with the data to be transmitted and thereby conveys the intended information to the RFID reader/interrogator.

In utilizing RFID in this embodiment, it is possible for over 4 billion users or patrons within one local area, with their own separate tags, each with a unique ID (or tag identification) number to have a packet of information extracted by simply walking by, near or through an interrogator Unit at any or several locations within the amusement park facility.

It should be mentioned that RFID tags are typically very practical for attachment to an individual's body in that they are commonly the size of a couple of square centimeters and often nearly paper-thin. Further, the tags are of very inexpensive.

The use of FM (frequency modulation) radio, however, has only become practical in low-cost highly integrated applications in recent years. It is possible to design and produce miniature FM receivers that can be manufactured inexpensively in volume.

A single transmitter in the field located together with the CCS can transmit information to thousands and tens-of-thousands of FM radio receivers in one local area. Such local area paging networks (LAP's) can be implemented for relatively low costs as a single pager transmitter can be purchased off-the-shelf and a single pager transmitter would be sufficient for smaller installations of with less than 5,000 patrons.

In present technology form, LAP transmitters of are available in two primary frequency bands: 460 MHz and 900 MHz. Whereas a predominance of 460 MHz systems in manufacture and for sale making them the most cost effective choice.

In wearing a small commercial size pager or even one fitted in the form of a watch as shown in FIG. 5, the patron of the amusement park could be constantly updated with a recommended time to return to a number of rides as well as information that would make his visit more enjoyable, such as:

Which rides have the shortest lines

When certain areas of the park are open or closed

When a particular seminar or talk will be held next.

Beep and announce that the park is closing

Help locate a lost party

Spread spectrum technology is desirable to link the processors near the rides to the central processor because it is highly immune to noise, interference and jamming. Also, the FCC allows a higher output power by the transmitter due to the process gain attainable in a spread spectrum radio. Although these radios cost substantially more than the more common narrowband counterparts, they provide an indispensable level of performance.

The spread spectrum radio (SSR) section of the this embodiment permits communication between the arch interrogator with the data it has extracted from the tags worn by the patrons and the CCS controlling the queue which apprises the patrons of when they are to return to the respective ride, among other useful information.

The SSR's are located and interfaced both at the interrogator archway and at the CCS. When the patron walks by the interrogator, his tag is read and that data is instantaneously transmitted from the SSR connected to the interrogator to the SSR connected to CCS's. The data is thereafter logged in a personal computer (PC) which immediately relays information right back to the patron.

In addition to radio communication links, the fourth embodiment has computer processing requirements at three different points: between the interrogator and SSR at the archway reader, the central control station (CCS) which is connected to a second SSR and lastly in the pager receiver unit worn by the park patron.

The computers needed at the archway reader and CCS could most likely be standard PC's and purchased from practically any PC manufacturer with size being one of the only considerations. The computer in the pager receiver, however, would be a single chip microprocessor of peripheral interface controller scale. This would be required whether it is ultimately placed in a pager or watch housing.

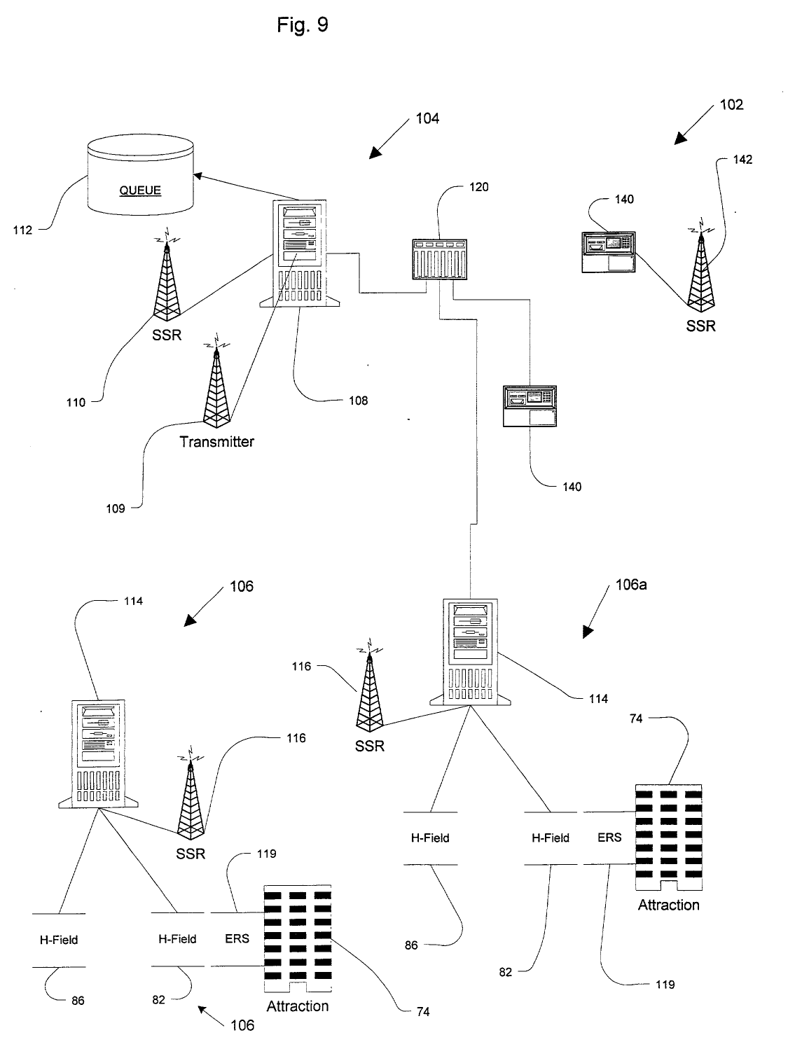

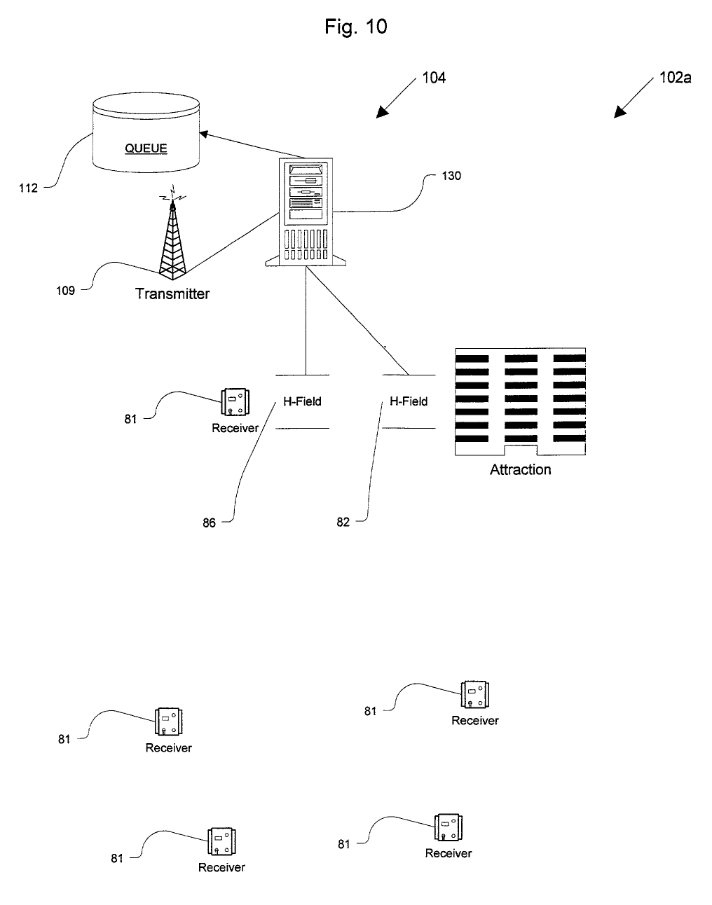

As shown in FIG. 9, the system 102 comprises the central processing station (CPS) 104 and attraction stations 106. The CPS 104 comprises the central processor 108 and a spread spectrum radio (SSR). The central processor 108 contains a database application therein holding the queue 112 described above. The attraction stations 106 comprise a processor 114 a spread spectrum radio 116 and a first H-field reader 86 and a second H-field reader 82. The H-field readers can be similar to that as shown in FIG. 6. The attraction station 106 further comprises an entry regulation system (ERS) 118. The entry regulation system 118 can be a turn booth type stall which either allows access or denies access to the attraction. The operation of the embodiment shown in FIG. 9 is very similar to that as shown in FIG. 6c where when a patron desires to have a place holding on the queue 112 therefore the patrons will walk through an interrogator 86. Specifically, referring to FIG. 6c, the patrons will view the display unit 88 to determine which spot on the ride the patron desires and further consider the approximate weight times displayed in on the unit 88. In some instances the patron may desire a longer wait time to provide a large interim period for other activities in the amusement park that would require a larger continuous segment of time.

After the patron passes the handheld unit receiver through the interrogator 86, the local processor 114 receives request and transmits a communication to the spread spectrum radio 116. The receiving spread spectrum radio 110 channels this communication to the central processor 108. The central processor creates a new place holding on the queue for the patron possessing the receiver. Thereafter, the central processor 108 sends a signal to the transmitter 109, which delivers a paging message to the receiver confirming their approximate weight times.

Alternately, as soon as the receiver passes through the interrogator 86, an initial confirmation message can be delivered to the patron indicating that the unique identification tag of the receiver was successfully uploaded. This communication can be an audio signal on the H-field reader. Thereafter, the patron who gets the confirming signal committed from the transmitter 109 indicating their approximate weight times.

After the queue is decremented and the place-holding for the user is that the sufficient high priority position on the queue, the patron's receiver will receive a message indicating that she must return to the attraction. Upon returning to the attraction, the display screen 87 could indicate which line 82 she is to go through in case she forgot. Upon passing through the second set of H-field readers 82, a second signal is sent to the spread spectrum radio 116 which is received by the spread spectrum radio 110 and the central processor 108 removes the place holding from the queue 112. Of course, this data as well as all the data received by the central processor 108 could be recorded in alternate tables on the database for historical purposes. For example, the patrons may want to have an agenda as to what rides they went on. Further, this data collection is very useful for statistics and regression analysis regarding the pleasure consuming habits of the patrons.

Alternately, the attraction stations 106a could be hardwired to a central hub 120. This embodiment is feasible, however the cost of implementing a category five cable 122 can be very cost prohibitive. Therefore, employing a radio can indication device such as the spread spectrum radio is preferred.

The kiosks 140 can further be hardwired to the central hub 120 or alternatively further have a spread spectrum antenna 142 that communicates with the main spread spectrum receiver 110. The kiosk provide various functionality such as allowing patrons the opportunity to page other patrons and send text messages in the park or alternatively create place-holding on the queue for any given ride.

FIG. 10 shows a simplified form 102a of the present invention where the central processor and queue 112 can have the functionality solely on the local processor 114. In this form, there would be a single attraction and a single queue. Hence the spread spectrum radios would not be needed. This embodiment is advantageous in a setting outside of the amusement park. For example, if an individual provides pony rides where young children ride a pony or small horse for a number of laps. Each ride takes an appreciable amount time and even a small line of 20 to 30 children can create a wait time of up to an hour or more. Therefore, the present invention is particularly advantageous in this scenario where each child would pay up front for the pony ride and receive a receiving device. The receiving device 81 would be scanned through an H-field reader 86. The H-field reader can be an archway walk through type or a small reader that the receiver can be passed through. Or alternately the unique ID for the receiver can otherwise be placed on to the central processor 130. Thereafter, the children can roam the facilities, which may not be associated with the proprietor of the pony rides. After a period of time, the receiver will indicate to the child that he or she must return back to the pony ride facility. Upon returning to the pony ride attraction, the child would return the receiver unit to the proprietor and could optionally keep the wristband as shown in FIG. 5. Of course any number of attractions would be suitable for the present invention, including such implementations such as a return desk at a department store which is particularly crowded after a holiday season.

It can be appreciated that the central processor can associate a number of types of data with the unique ID of the receiver. For example, a credit limit could be applied to the unique ID of each receiver where the receiver can effectively be used as a credit card around in amusement park.

A further aspect of the present invention is having the receivers further be employed at the concessions and gaming portion of an amusement park. Whereas, when the patron makes the purchase, this purchase is identified with the receiver tag number and data can be collected about the consuming habits for this purchaser.

The applicant has disclosed herein numerous embodiments and configurations to more than adequately inform the public of the invention. The applicants truly desires that the specification is not confusing by disclosing the rudimentary ramifications and permutations of the basic invention described herein in the appended claims, but the applicant believes such an exhausting length of text is necessary to acquire the proper protection in the following claims.

I claim:

1. A system to substantially remove lines for an attraction where a number of patrons desire to attend the attraction and the system comprises:
a transmitter system having a transmitter device adapted to transmit signals,
a central processor comprising a queue and a processing system, where the processing system transmits signals to transmitter system for sending information therefrom, and the queue is adapted to hold place-holdings which contain the unique identification tags,
a plurality of receivers each having unique identification tags and the receivers adapted to receive the said information from the transmitter system transmitted from the central processor,
a queue setting operation comprising a first interrogator adapted to receive signals from the receivers where the first reader uploads the unique identification tags of the receivers and the first reader is in communication with the central processor to transmit information thereto,
a queue decrementing operation comprising a second interrogator that is adapted to receive signals from the said receivers where the second reader uploads the unique identification tags of the receivers, the second interrogator is in communication with the central processor and signals from the queue decrementing operation are adapted to remove place holdings from the queue where the place holdings comprise the unique identification tags from the respective receivers,
an entrance regulation system adapted to permit or deny entrance to the attraction for the patrons where the entrance regulation system is controlled by the queue decrementing operation where when a place holding is removed from the queue, the entrance regulation system is adapted to allow access for the patron possessing the receiver having the unique identification of the place holding that was removed from the queue,
whereas, a patron indicates to the first interrogator of the queue setting operation a request to have a place-holding in the queue, the central processor receives the request and creates a place-holding on the queue where the place-holding comprises the identification tag, as higher priority place-holdings are removed from the queue, the lower-priority place holdings advance in the queue, the receiver transmits its unique identification tag to the queue decrementing operation where the second interrogator reads the unique identification tag and the unique identification tag is transmitted to the central processor to query the for a place-holding having the same identification tag and if the returned place-holding is within a specified high priority range, the entrance regulation system allows the user to enter to the event.

2. The system as recited in claim 1 further comprising:
where the first interrogator is an magnetic field of reader adapted to transmit a magnetic signal.

3. The system as recited in claim 1 further comprising:
where the second interrogator is an magnetic field producing reader adapted to transmit a magnetic signal.

4. The system as recited in claim 2 further comprising:
where the second interrogator is an magnetic field producing reader adapted to transmit a magnetic field.

5. The system as recited in claim 2 further comprising:
where the receivers passively receive signals from the antenna transmitter system and comprise circuitry to upload information to the queue setting operation as the receivers pass through the magnetic field.

6. The system as recited in claim 3 further comprising:
where the receivers passively receive signals from the transmitter system and comprise circuitry to upload information to the queue setting operation as the receivers pass through the magnetic field.

7. The system as recited in claim 1 further comprising:
where the user inputs place holdings the central processor through a user interface.

8. The system as recited in claim 7 where the user interface is a display at a kiosk.

9. The system as recited in claim 7 where the user interface is a display on the computer and a communication transmission system provides communication to the queue by request through the Internet.

10. The system as recited in claim 1 further comprising:
where the system is adapted to be placed in an amusement park.

11. The system as recited in claim 1 further comprising where the first and second interrogators operate on the same hardware.

12. The system as recited in claim 1 further comprising:
where the queue setting and decrementing operations are connected to a second processor and a transmitter system sends signals to the central processor to update the queue.

13. The system as recited in claim 12 where the transmitter system comprises spread spectrum transmitters and receivers to sending information to the central processor.

14. The system as recited in claim 12 further comprising:
where a plurality of second processors are employed and used at a plurality attractions where the transmitter system of each second processor updates the central processor in real time to update the queue.
